(19) United States
(12) Patent Application Publication
(10) Pub. No.: US 2026/0090632 A1
(43) Pub. Date: Apr. 2, 2026

(54) MULTIPURPOSE DEVICE FOR PERSONAL HYGIENE

(71) Applicant: Anthony Nerkowski, Gagetown, MI (US)

(72) Inventor: Anthony Nerkowski, Gagetown, MI (US)

(21) Appl. No.: 18/900,713

(22) Filed: Sep. 28, 2024

(51) Int. Cl. A46B 15/00; A46B 11/00; A46B 17/04; A61C 15/02; A61C 15/04; A61C 17/02

(52) U.S. Cl. CPC A46B 15/0073; A46B 11/0006; A46B 11/0086; A46B 15/0065; A46B 17/04; A61C 15/02; A61C 15/043; A61C 17/0202; A46B 2200/1066

(57) ABSTRACT

A multipurpose device for personal hygiene includes a brush for cleaning and brushing teeth and extending to a housing defining and outer wall presenting a shoulder and a cavity defined in the housing presenting an inner wall. The multipurpose component is disposed inside the cavity and defines an axis extending through the multipurpose component and the housing. The multipurpose component presents an element allowing the human to floss between the teeth and further allowing the human to selectively splay fluid into mouth through an open end of the housing and cleaning bits of food out of the teeth by removing a toothpick from a cap.

### FIELD OF THE INVENTION

The present invention relates generally to an oral cleaning product such as toothbrushes combined with toothpicks.

### BACKGROUND OF PRIOR ART

There are multiple common oral cleaning products currently available on the market including toothbrushes, toothpastes, mouthwashes, and flossing products. When eating, foods are easily caught between the teeth of two adjacent teeth by chewing. People use toothbrushes after eating but unfortunately toothpaste may not completely remove the food residue in the tooth gaps. In some case, people use mouthwash but even mouthwash does not completely remove the food residue from the tooth gap.

A prior art reference, such as U.S. Pat. No. 10,010,166 to Eduardo J. Jimenez teaches an oral care implement having a cover member. In one aspect, the invention is an oral care implement comprising: a body comprising a handle and a head, the head comprising a coupling element; a store of oral care material located within the body; an outlet located on the head and in fluid communication with the store; a cover member comprising a cap portion, a mounting portion, and a coupling element; and wherein the cover member is detachably coupled to the head via cooperation between the coupling element of the cover member and the coupling element of the head, and the mounting portion is configured to mount the oral care implement to a vertical surface.

Still another prior art reference, such as U.S. Pat. No. 9,700,128B2 to Kennedy et al., for example, teaches an oral care system including a toothbrush and a dispenser that is detachably coupled thereto. In one aspect, the invention can be an oral care system comprising: a toothbrush comprising a handle, a head and a plurality of tooth cleaning elements extending from the head; and a dispenser detachably coupled to the toothbrush, the dispenser comprising a housing, a first reservoir chamber disposed in the housing containing a first oral care material, and a second reservoir chamber disposed in the housing containing a second oral care material, the second oral care material different than the first oral care material.

Still another prior art reference, such as U.S. Pat. No. 10,154,728B2 to Miriam Hailechristos, on the other hand teaches a toothbrush comprising a brush head and neck, a hollow toothpaste storage chamber, and a plunger, in which the brush head has bristles and one or more apertures, and the neck is hollow. A portion of the plunger sits inside of the hollow storage chamber, and a spring sits inside of the hollow plunger. Alternatively, the plunger has a rod that has teeth on one side and a groove on the other side, to lock or unlock the plunger.

All of the aforementioned products are bulky, complicated in design and manufacturing and most importantly do not incorporate all elements in one that will allow brush, floss, pick, and rinse. Another drawback and inconvenience of the aforementioned prior art products is failure to offer a solution where the product can be used during travel and will be easily carried by the user.

Therefore, there is a need for a multipurpose device for personal hygiene, which incorporates all elements in one that will allow the user brush, floss, pick, and rinse and will offer a solution where the product can be used during travel and will be easily carried by the user.

### SUMMARY OF THE INVENTION

To address or solve the drawback of the current technology discussed above, the present invention provides a multipurpose device for personal hygiene (the device), which includes a brush for cleaning and brushing teeth. The brush extends to a housing defining and outer wall presenting a shoulder and a cavity defined in the housing presenting an inner wall. The housing extends to an open end. A cap removably covering the brush, the cap nests on the shoulder. A multipurpose component is disposed inside the cavity and defines an axis extending through the multipurpose component and the housing.

The multipurpose component presents an element allowing the human to floss between the teeth and further allowing the human to selectively spray fluid into mouth through the open end of the housing and cleaning bits of food out of the teeth by removing a toothpick from the cap.

The multipurpose component is further defined by a container to hold the fluid. The container presents a bottom and a neck portion presenting a head and a conduit extending from the head to spray the fluid into the mouth through the open end of the housing. The multipurpose component is further defined by a spool element presenting a base adjacent the bottom of the container and a post extending from the base of the spool element to hold the element further defined floss, wherein the floss further extends through an orifice defined in the housing thereby allowing to floss between the teeth.

A cutter defined in the orifice to cut the floss as needed. A second cap is used to cover the head and the conduit extending from the head. A neck portion has end portions of a first thickness and an inner wall of a second thickness. The inner wall is defined between the end portions to allow the human to snap and remove the toothpick from the cap. One of the end portions is connected to an inner side of the toothpick and another of the end portions is connected to an outer surface of the cap.

Another alternative embodiment discloses a multipurpose device including a brush for cleaning and brushing teeth and extending to a housing defining and outer wall presenting a shoulder. A cap is removably covering the brush and defining an inner surface of the cap. A toothpaste element is connected to and extending substantially over the inner surface of the cap allowing the user to rub the brush against the toothpaste element to deposing a toothpaste onto the brush to clean and brush teeth multiple times.

An advantage of the present invention is to provide an inventive product, which is not bulky, complicated in design and manufacturing and most importantly incorporates all elements in one that will allow brush, floss, pick, and rinse.

Another advantage of the present invention is to provide an inventive product, which offers a solution where the product can be used during travel and will be easily carried by the user.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a multipurpose device for personal hygiene (the device);

FIG. 2 is an exploded view of the device;

FIG. 3 is a fragmental view showing a cap and a toothpick broken away from the cap;

FIG. 4 is a fragmental view of a dispenser from spraying a mouth fluid and a cover disengaged from the dispenser;

FIG. 5 is a cross sectional view of the device;

FIG. 6 is a is a perspective view of an alternative embodiment of the device;

FIG. 7 is a cross sectional view of a first alternative embodiment of the cap;

FIG. 8 is a cross sectional view of a second alternative embodiment of the cap;

FIG. 9 is a cross sectional view of a third alternative embodiment of the cap;

FIG. 10 is an exploded view of a fourth alternative embodiment of the cap;

FIG. 11 is a perspective view of another embodiment of the toothpaste insert shown in FIG. 10;

FIG. 12 is an exploded view of a fifth alternative embodiment of the cap; and

FIG. 13 is a cross sectional view of the cap and the toothbrush frictionally rubbing the toothpaste layer located inside the cap to form a toothpaste on the toothbrush.

### DETAILED DESCRIPTION OF THE INVENTION

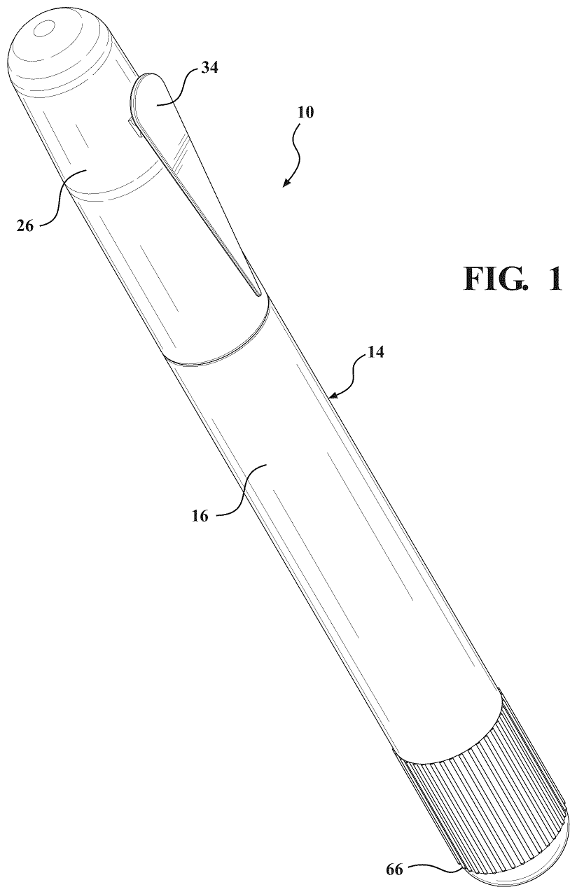

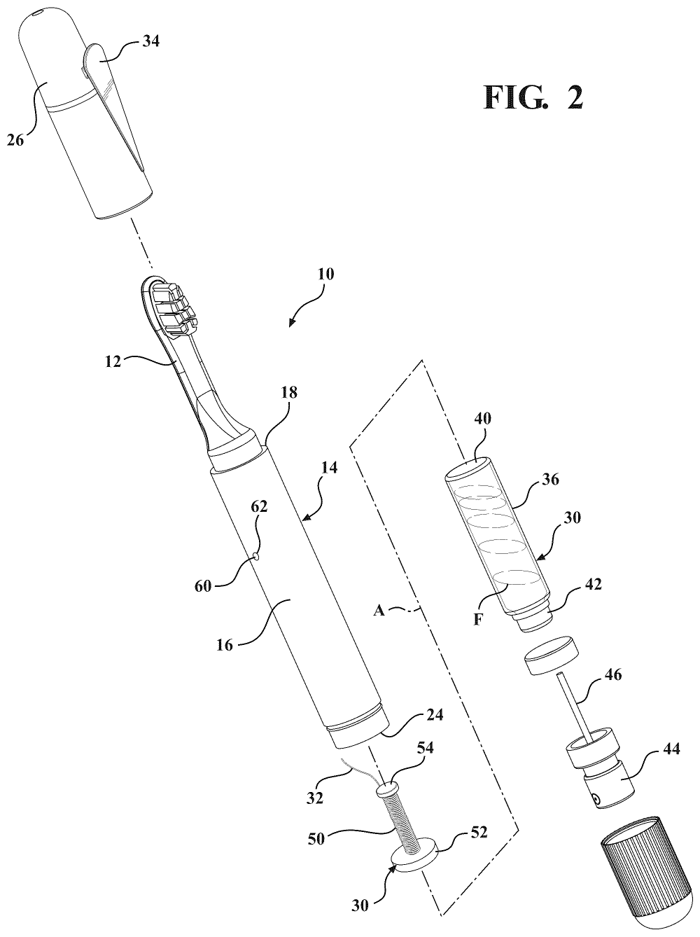

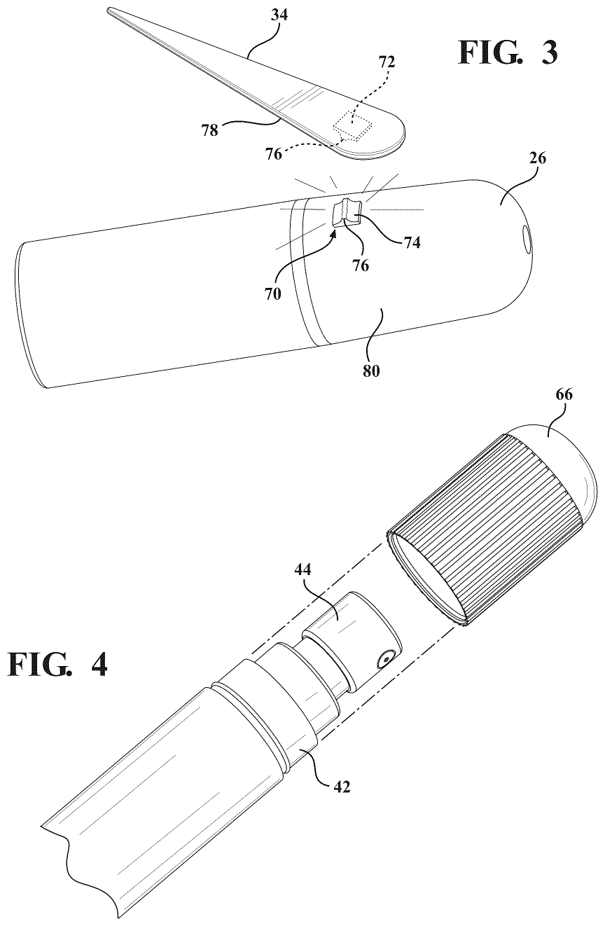

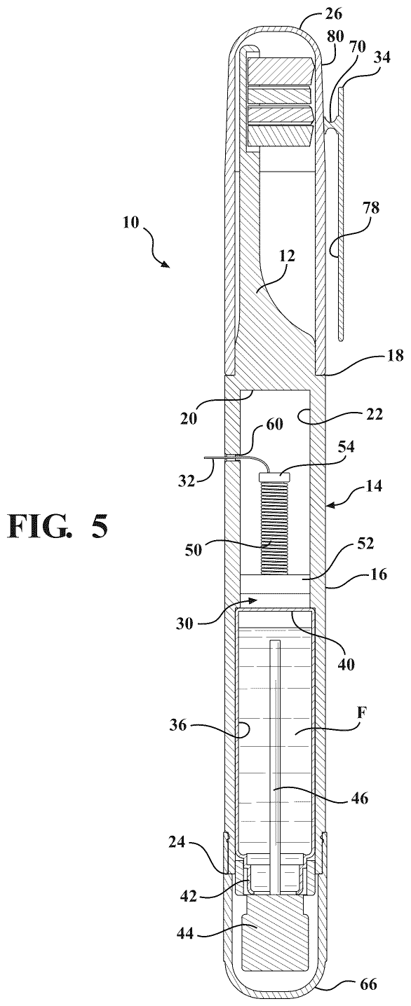

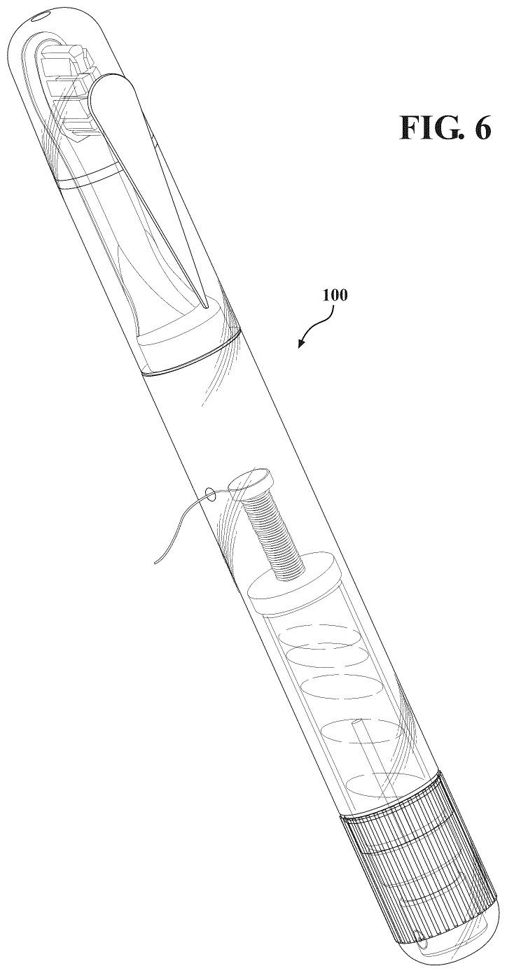

Referring to the figures, a multipurpose device for personal hygiene (the device) is generally shown at 10 in FIGS. 1-5, wherein an alternative embodiment of the device is generally shown at 100 in FIG. 6. Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Additionally, as used herein, the singular forms “a,” “an,” and “the” include plural referents unless the context clearly dictates otherwise. Thus, for example, the term “module” is intended to mean one or more modules or a combination of modules. Furthermore, as used herein, the term “based on” includes based at least in part on. Thus, a feature that is described as based on some cause, can be based only on that cause, or based on that cause and on one or more other causes.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Referring now to the drawings and the illustrative embodiments depicted therein, as best shown in FIGS. 1 through 5, the multipurpose device 10 includes a brush 12 for cleaning and brushing teeth. The brush 12 extends to a housing, generally indicated at 14, defining and outer wall 16 presenting a shoulder 18 and a cavity 20 defined in the housing 14 presenting an inner wall 22.

The housing 14 extends to an open end 24. A cap 26 removably covers the brush 12. The cap 26 nests on the shoulder 18. A multipurpose component, generally indicated at 30, is disposed inside the cavity 20 and defines an axis A extending through the multipurpose component 30 and the housing 14.

The multipurpose component 30 presents an element 32 allowing the human to floss between the teeth and further allowing the human to selectively spray fluid F into mouth through the open end 24 of the housing 14 and cleaning bits of food out of the teeth by removing a toothpick 34 from the cap 26.

The multipurpose component 30 is further defined by a container 36 to hold the fluid F. The container 36 presents a bottom 40 and a neck portion 42 presenting a head 44 and a conduit 46 extending from the head 44 to spray the fluid F into the mouth through the open end 24 of the housing 14. The multipurpose component 30 is further defined by a spool element 50 presenting a base 52 adjacent the bottom 40 of the container 36 and a post 54 extending from the base 52 of the spool element 50 to hold the element 32 further defined floss, wherein the floss 32 further extends through an orifice 60 defined in the housing 14 thereby allowing to floss between the teeth.

A cutter 62 defined in the orifice 60 to cut the floss 32 as needed. A second cap 66 is used to cover the head 44 and the conduit 46 extending from the head 44. A neck portion 70 has end portions 72, 74 of a first thickness and an inner wall 76 of a second thickness. The inner wall 76 is defined between the end portions 72, 74 to allow the human to snap and remove the toothpick 34 from the cap 26. One of the end portions 72 is connected to an inner side 78 of the toothpick 34 and another of the end portions 74 is connected to an outer surface 80 of the cap 26.

FIG. 6 illustrates an alternative embodiment of the embodiment of the device, generally shown at 100. The body of the device 100 is clear, i.e. transparent. Both devices 10 and 100 are formed from polymeric materials without limiting the cope of the present invention. Both devices 10 and 100, as shown herewith, present a circular cross section but may also present a non-circular cross section, such as rectangular, triangular, and nothing in configuration of the cross sections is not intended to limit the scope of the present invention. The toothbrush is covered by a solution that turns into a toothpaste upon contact with fluid such as water or saliva.

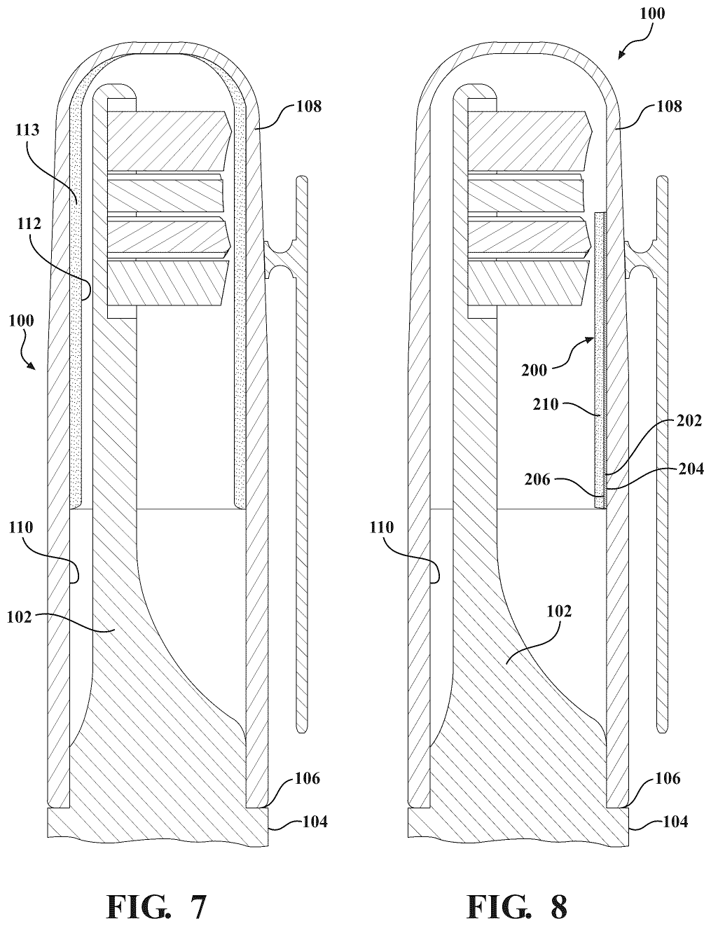

FIGS. 7 through 12 illustrates several alternatives embodiments of the present invention. FIG. 7 shows a first alternative embodiment of the multipurpose device for personal hygiene, generally shown at 100. The device 100 includes a brush 102 for cleaning and brushing teeth. The brush 102 extends to the housing defining and outer wall 104 presenting a shoulder 106. A cap 108 is removably covers the brush 102 and defines an inner surface 110 of the cap 108, wherein the cap 108 nests on the shoulder 106. A toothpaste element 112 is connected to and extends substantially over the inner surface 110 of the cap 108 allowing the use to rub the brush 102 against the toothpaste element 112 to deposing a toothpaste 113 onto the brush 102 to clean and brush teeth multiple times.

Those skilled in the art will appreciate that different fusing and connecting methods can be used to attach the toothpaste element 112 to the inner surface 110. The toothpaste element 112 is formed from a material that are solid until any impact of fluid which can be water or saliva of the user to form a toothpaste, as shown in FIG. 13, to be applied on teeth.

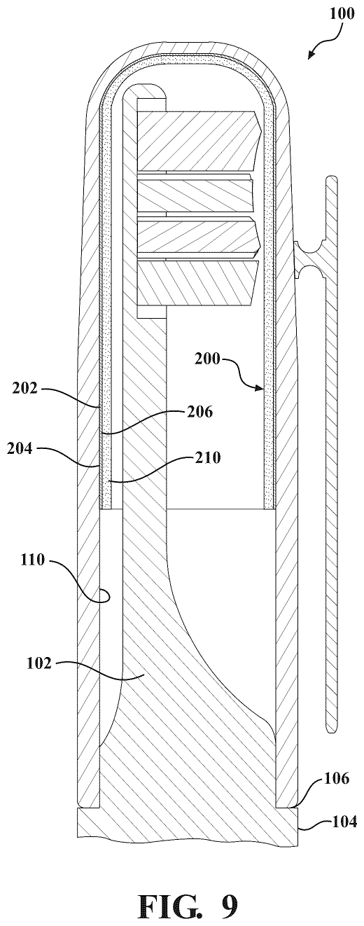

FIGS. 8 and 9 show a second alternative embodiment of the multipurpose device for personal hygiene 100. A toothpaste element, generally indicated at 200, is further defined by a film 202 having two sides 204 and 206 where one of the sides 204 is connected to the inner surface 110 of the cap 108 and another side 206. A paste substance 210 is applied to the side 206. As shown in FIG. 8, the film 202 covers the entire of the inner surface 110 of the cap 108. FIG. 9 shows the film 202 covers the entire of the inner surface 110 of the cap 108.

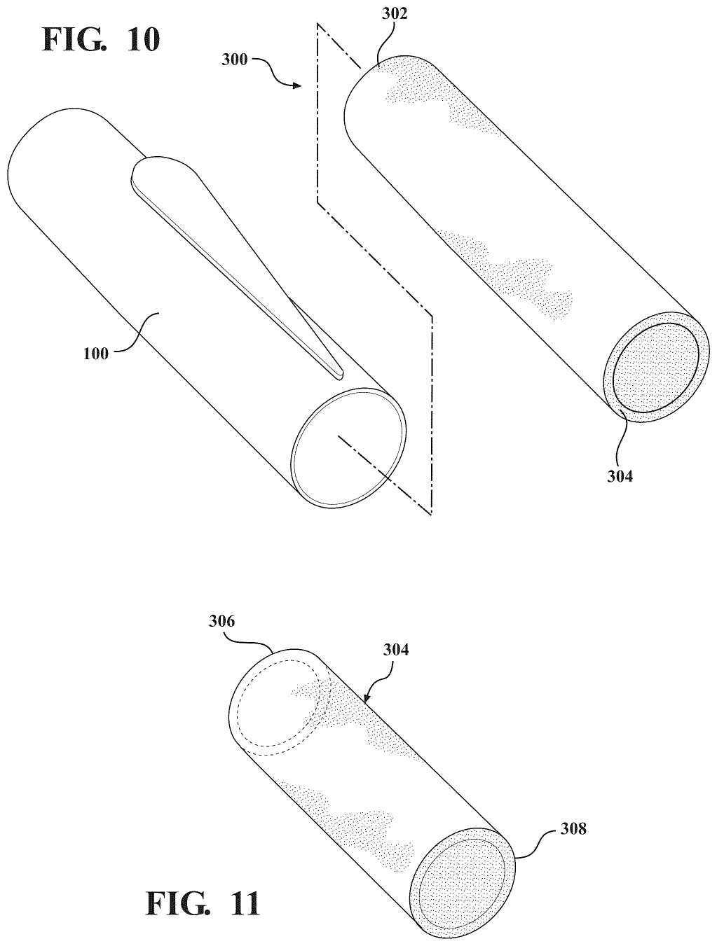

FIG. 10 shows yet another alternative embodiment of a toothpaste element, shown at 300, defined by an insert device formed from the paste substance and having one end 302 enclosed and another end 304 being opened to receive the brush 102. The insert device 300 is inserted into the cap 100. FIG. 11 shows an alternative embodiment of the insert device, generally indicated at 304, having two open ends 306 and 308.

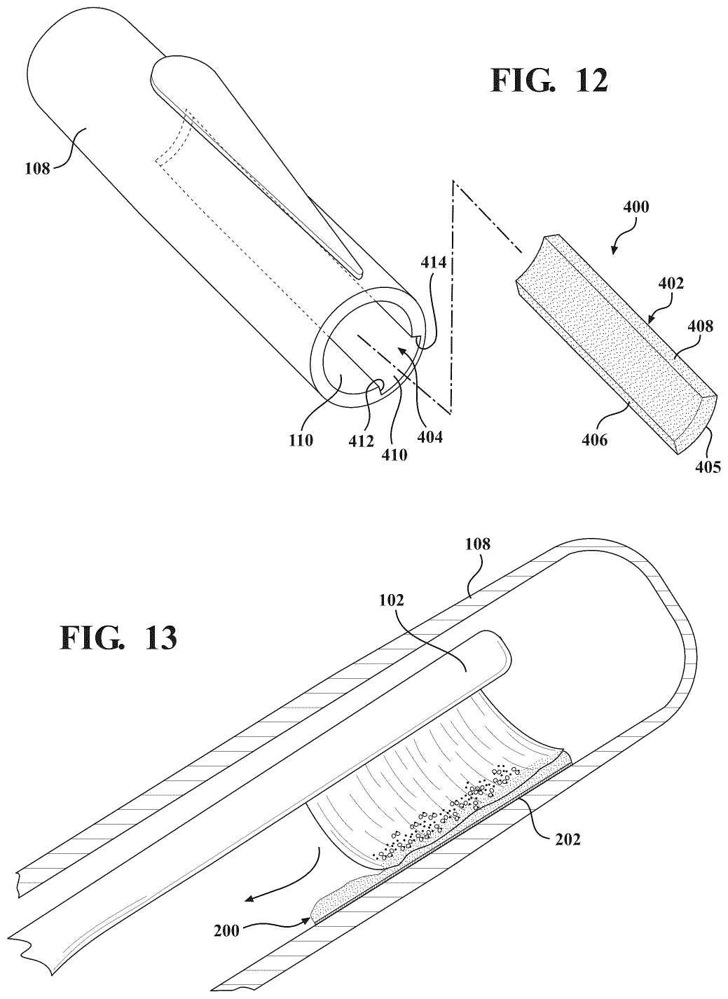

FIG. 12 shows yet another alternative embodiment of a toothpaste element, shown at 400. The toothpaste element 400 is defined by an insert bar, generally indicated at 402, formed from the paste substance and a groove, generally indicated at 404, defined in the inner surface 110 of the cap 108 to receive the insert bar 402 in male and female fashion. The insert bar 402 presents a convex bottom 405 and inclined side walls 406 and 408 to mate with a convex bottom 410 of the groove 404 and inclined sides 412 and 414 of the groove 404 to mechanically engage with the convex bottom 405 and the inclined side walls 406 and 408 of the insert bar 402.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing.

The drawing shows illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A multipurpose device for personal hygiene of a user, said multipurpose device comprising:
a brush for cleaning and brushing teeth, said brush extending to a housing defining and outer wall presenting a shoulder and a cavity defined in said housing presenting an inner wall;
a cap removably covering said brush and defining an inner surface of said cap, said cap nesting on said shoulder; and
a toothpaste element connected to and extending substantially over the inner surface of said cap allowing the user to rub said brush against said toothpaste element to deposing a toothpaste onto said brush to clean and brush teeth multiple times.

2. The multipurpose device for personal hygiene a set forth in claim 1, wherein said toothpaste element is further defined by a paste substance applied to said inner surface of said cap.

3. The multipurpose device for personal hygiene a set forth in claim 1, wherein said toothpaste element is further defined by a film having two sides where one of said sides is connected to said inner surface of said cap and another of said sides will include said paste substance applied thereto.

4. The multipurpose device for personal hygiene a set forth in claim 1, wherein said toothpaste element is further defined by a film having two sides where one of said sides is connected to said inner surface of said cap and another of said sides will include said paste substance applied thereto.

5. The multipurpose device for personal hygiene a set forth in claim 4, wherein said film covers the entire of said inner surface of said cap.

7. The multipurpose device for personal hygiene a set forth in claim 1, wherein said film covers the entire of said inner surface of said cap.

8. The multipurpose device for personal hygiene a set forth in claim 7, wherein said toothpaste element is further defined by an insert device formed from said paste substance and having one end enclosed and another end being opened to receive said brush, said insert being inserted device into said cap.

9. The multipurpose device for personal hygiene a set forth in claim 7, wherein said toothpaste element is further defined by an insert bar formed from said paste substance and a groove defined in said inner surface of said cap to receive said insert bar in male and female fashion.

10. The multipurpose device for personal hygiene a set forth in claim 9, wherein said insert bar presents a convex bottom and inclined side walls to mate with a convex bottom of said groove and inclined sides of said groove to mechanically engage with said concave bottom and said inclined side walls of said insert bar.

11. The multipurpose device for personal hygiene a set forth in claim 1, wherein a multipurpose component disposed inside said cavity and defining an axis extending through said multipurpose component and said housing, said multipurpose component presenting an element allowing the human to floss between the teeth and further allowing the human to selectively spray fluid into mouth through said open end of said housing and cleaning bits of food out of the teeth by removing a toothpick from said cap.

12. The multipurpose device for personal hygiene a set forth in claim 11, wherein said multipurpose component is further defined by a container to hold the fluid, said container presenting a bottom and a neck portion presenting a head and a conduit extending from said head to spray the fluid into the mouth through said open end of said housing.

13. The multipurpose device for personal hygiene a set forth in claim 12, wherein said multipurpose component is further defined by a spool element presenting a base adjacent said bottom of said container and a post extending from said base of said spool element to hold said element further defined floss, wherein said floss further extends through an orifice defined in said housing thereby allowing to floss between the teeth.

14. The multipurpose device for personal hygiene a set forth in claim 13, including a cutter defined in said orifice to cut said floss as needed.

15. The multipurpose device for personal hygiene a set forth in claim 14, including a second cap to cover said head and said conduit extending from said head.

16. The multipurpose device for personal hygiene a set forth in claim 15, including a neck portion having end portions of a first thickness and an inner wall of a second thickness, with said inner wall defined between said end portions to allow the human to snap and remove said toothpick from said cap.

17. The multipurpose device for personal hygiene a set forth in claim 16, wherein one of said end portions is connected to an inner side of said toothpick and another of said end portions is connected to an outer surface of said cap.
